(19) United States
(12) Patent Application Publication
(10) Pub. No.: US 2026/0066544 A1
(43) Pub. Date: Mar. 5, 2026

(54) Dual Band Tapered Slot and Loop Ground Edge Radiating Antenna Structure

(71) Applicant: Silicon Laboratories Inc., Austin, TX (US)

(72) Inventor: Tommi Linnala, Espoo (FI)

(21) Appl. No.: 18/816,731

(22) Filed: Aug. 27, 2024

(51) Int. Cl. H01Q 13/10; H01Q 5/307

(52) U.S. Cl. CPC H01Q 13/10; H01Q 5/307

(57) ABSTRACT

A dual band antenna structure is disclosed. The dual band antenna structure utilizes features from loop ground edge radiating antennas and tapered slot antennas to create an antenna that has at least two resonance frequencies. The dual band antenna structure includes a loop ground edge radiating antenna, which has a first resonance frequency. The trace used to create the loop ground edge radiating antenna is shaped to also serve as part of a tapered slot antenna to provide a second resonance frequency. The dual band antenna structure is useful for network devices that operate at multiple frequencies, such as those using the

### BACKGROUND

This disclosure describes an antenna system, and more particularly an antenna having at least two different frequency bands.

The explosion of network connected devices has led to an increased use of certain wireless protocols. Further, many of these network connected devices are configured to operate on multiple networks, or at multiple frequencies.

Various types of antenna structures are used in these devices. FIG. 1 shows a conventional loop ground edge radiating antenna. Typically, much of the top layer of the printed circuit board comprises a ground plane 15. The ground clearance 16 is a region of the top layer, which is not electrically conductive. In certain embodiments, the metal that typically resides in this region is removed. The ground clearance 16 may be rectangular in shape. The dimensions of the ground clearance 16 may be selected based on the desired performance of the antenna. For example, the width of the ground clearance 16 may affect the resonant frequency while the other dimension affects the bandwidth of the antenna.

An antenna radiator loop is created around the outside of the ground clearance 16. This antenna radiator loop allows the spread of loop-type current distributions on the ground plane 15 to be radiated outward.

An RF feed 10 is used as the source of the RF signal. The RF feed 10 is in communication with the feeding trace 12. The feeding trace 12 may include a right angle that attaches to the loop trace 14. The feeding trace 12 and the loop trace 14, like the rest of the ground plane 15, are a conductive material, such as copper.

The ground clearance 16 may be formed near the edge of the ground plane 15, such that the distance between the edge of the ground plane 15 and the ground clearance 16 proximate that edge is about 0.5 mm. Thus, a conductive pathway exists between the ground clearance 16 and the edge of the ground plane 15.

One or more capacitors 13 are disposed in series along the loop trace 14, such that current passing along the loop trace 14 must pass through the one or more capacitors 13. The one or more capacitors 13 may have the same value or different values.

Additionally, an input capacitor 11 is disposed between the feeding trace 12 and the RF feed 10. The RF feed 10 may connect to an impedance matching circuit, which, in turn, is in communication with the power amplifier of the radio circuitry.

In operation, the current path around the ground clearance 16 forms the antenna radiator loop. In other words, the strong current loop allows the spread of loop-type current distributions on the ground plane 15 to radiate outward. In this configuration, the value of the one or more capacitors 13 and the dimensions of the ground plane controls both the input impedance and the resonant frequency of the antenna.

FIG. 2 shows a different type of antenna structure, referred to as a tapered slot antenna. Like the loop antenna, the tapered slot antenna includes a ground plane 26 and a ground clearance 28. The tapered slot antenna includes a microstrip 21 disposed on a different layer of the printed circuit board and capacitively coupled to the slot 22. The slot 22 is a narrow passage in the ground plane 26 which grows in width moving toward the edge of the printed circuit board. In some embodiments, the slot 22 is connected to an exponentially tapered slot. The tapered slot antenna is a broadband end-fire traveling wave type antenna.

However, each of these antenna structures may only be suitable for one frequency range. There are certain network protocols, such as WiFi, that have multiple operating frequencies, which may be separated by several GHz. Therefore, it would be beneficial if there was a single antenna structure that could operate effectively in two different frequency bands.

### SUMMARY

A dual band antenna structure is disclosed. The dual band antenna structure utilizes features from loop ground edge radiating antennas and tapered slot antennas to create an antenna that has two resonance frequencies. The dual band antenna structure includes a loop ground edge radiating antenna, which has a first resonance frequency. The trace used to create the loop ground edge radiating antenna is shaped to also serve as part of a tapered slot antenna to provide a second resonance frequency. The dual band antenna structure is useful for network devices that operate at multiple frequencies, such as those using the WiFi/BLE/IEEE802.15.4 protocols.

According to one embodiment, a dual band antenna is disclosed. The dual band antenna comprises a printed circuit board having a ground plane on a top layer, wherein the ground plane comprises a conductive material; a ground clearance disposed on the top layer, wherein the ground clearance lacks the conductive material; a loop ground edge radiating antenna comprising a radiator trace disposed in the ground clearance; and a tapered slot antenna formed by the radiator trace and a first edge of the ground plane. In some embodiments, the loop ground edge radiating antenna has a resonance frequency between 2.4 GHz and 2.5 GHz. In some embodiments, a bandwidth of the loop ground edge radiating antenna is at least 200 MHz. In some embodiments, the tapered slot antenna has a resonance frequency between 5.0 GHz and 6.0 GHz. In some embodiments, a bandwidth of the tapered slot antenna is at least 1000 MHz. In some embodiments, the ground clearance has dimensions that are equal to or less than 10 mm by 10 mm. In some embodiments, there are at least two different frequency ranges, wherein every frequency within the at least two different frequency ranges has a reflection coefficient of less than −10 dB. In certain embodiments, there are three frequency ranges.

According to another embodiment, a dual band antenna is disclosed. The dual band antenna comprises a printed circuit board having a ground plane on a top layer, wherein the ground plane comprises a conductive material; a ground clearance disposed on the top layer, wherein the ground clearance is rectangular shaped and lacks the conductive material, wherein a side of the ground clearance is an edge of the printed circuit board and a first edge and a second edge are adjacent to the side; a tuning trace disposed in the ground clearance, a proximal end of the tuning trace in communication with an input capacitor and a RF feed; and a radiator trace in communication with a distal end of the tuning trace, wherein a first portion of the radiator trace is adjacent to the first edge so as to form a slot, and a second portion of the radiator trace extends away from the first edge and toward the second edge, and wherein a distal end of the second portion is capacitively coupled to the ground plane at the second edge. In some embodiments, a capacitor is in communication with the ground plane at the second edge and the distal end of the second portion of the radiator trace. In some embodiments, a trace arm extension is disposed parallel to the second edge to capacitively couple the distal end of the second portion to the ground plane. In certain embodiments, the trace arm extension is disposed between 0.2 mm and 0.5 mm from the second edge. In some embodiments, the slot has a width of between 0.1 and 0.5 mm. In certain embodiments, the slot has a length of between 0.5 and 2.0 mm. In some embodiments, the ground clearance has dimensions that are equal to or less than 10 mm by 10 mm. In some embodiments, the second portion of the radiator trace is rounded and is closer to the edge of the printed circuit board at the distal end than at a proximal end. In some embodiments, the second portion of the radiator trace is straight and slants toward the second edge. In certain embodiments, the distal end of the second portion is closer to the edge of the printed circuit board than a proximal end.

According to another embodiment, a network device is disclosed. The network device comprises a processing unit; a memory device in communication with the processing unit; a network interface in communication with any of the dual band antennas described above; and a data memory device to store data to be transmitted and received using the dual band antenna.

### BRIEF DESCRIPTION OF THE DRAWINGS

For a better understanding of the present disclosure, reference is made to the accompanying drawings, in which like elements are referenced with like numerals, and in which:

FIG. 1 shows the topology of a loop ground edge radiating antenna according to the prior art;

FIG. 2 shows the topology of an tapered slot antenna according to the prior art;

FIG. 3 shows the topology of the present dual band antenna according to one embodiment;

FIG. 4 shows the topology of the present dual band antenna according to a second embodiment;

FIG. 5 shows a modification to the dual band antenna of FIG. 5;

FIG. 6A shows the current distribution of the present dual band antenna when radiating at 2.45 GHz;

FIG. 6B shows the current distribution of the present dual band antenna when radiating at 5.5 GHz;

FIG. 7 shows the reflection coefficient of the dual band antenna;

FIG. 8 show the antenna efficiency of the present dual band antenna; and

FIG. 9 shows a representative network device that utilizes the dual band antenna described herein.

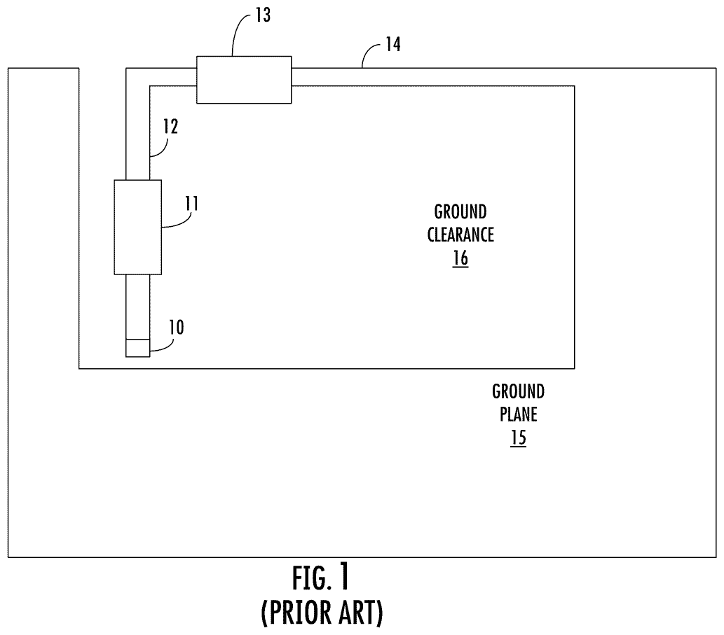

### DETAILED DESCRIPTION

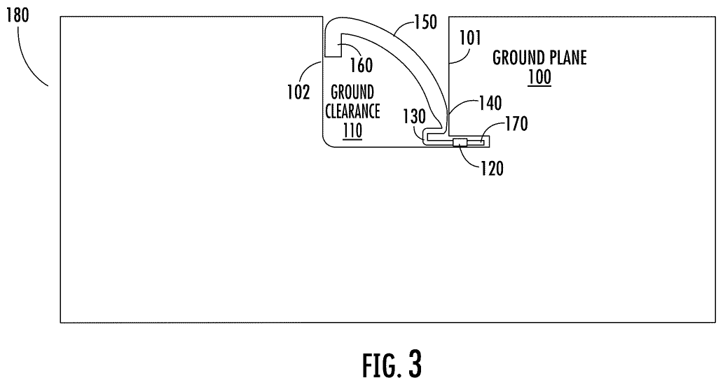

FIG. 3 shows the topology of an antenna structure that overcomes the issues of the prior art. The antenna structure incorporates features from both the loop ground edge radiating antenna and the tapered slot antenna. Consequently, it is able to operate at at least two different frequency ranges, thereby serving as a dual band antenna.

The antenna structure is disposed on the top layer of a printed circuit board 180. Much of the top layer may be a ground plane 100. The ground plane 100 comprises a conductive layer, such as copper, disposed on the top layer of the printed circuit board 180, which is electrically connected to ground. The ground clearance 110 is a region of the top layer, which is not electrically conductive. In certain embodiments, the metal that typically resides in this region is removed. The ground clearance 110 may be rectangular in shape. In some embodiments, the ground clearance 110 may be 10 mm or smaller in length and width. One of the sides of the rectangularly shaped ground clearance may be an edge of the printed circuit board 180. The dimensions of the ground clearance 110 may be selected based on the desired performance or resonance frequencies of the antenna structure. Note that the ground plane 100 extends to the edge of the printed circuit board 180 on both sides of the ground clearance 110. The ground clearance 110 is also bounded by two edges that are orthogonal to the edge of the printed circuit board 180; a first edge 101 and a second edge 102, which is opposite the first edge 101.

An RF feed 170 is provided within the ground clearance 110. The RF feed 170 is electrically connected to the tuning trace 130, which is disposed in the ground clearance 110. The width of the tuning trace 130 may be any suitable width. In one embodiment, the width of the traces may be about 0.4 mm since this aligns with the solder footprint of the input capacitor 120.

Additionally, an input capacitor 120 is disposed between the tuning trace 130 and the RF feed 170. The RF feed 170 may connect to an impedance matching circuit, which, in turn, is in communication with the power amplifier of the radio circuitry.

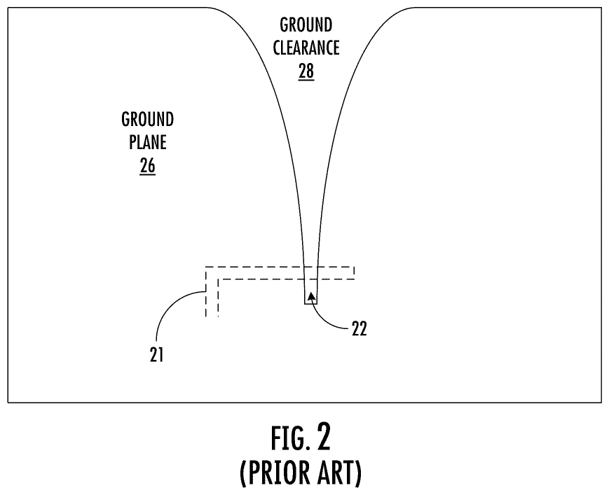

The tuning trace 130 is electrically connected to a radiator trace 150, which has a first portion that is disposed adjacent to the first edge 101 to form a slot 140. In some embodiments, the width of the slot 140 may be between 0.1 and 0.5 mm. The length of the slot 140 is between 0.5 and 2 mm. After the slot 140, a second portion of the radiator trace 150 travels away from the first edge 101 toward the second edge 102. The shape of the second portion of the radiator trace 150 in this embodiment is rounded, creating half of the tapered slot shown in FIG. 2. In other words, the radiator trace 150 moves closer to the edge of the printed circuit board 180 as it travels toward the second edge 102. The second end of the radiator trace 150 then attached to a trace arm extension 160, which is parallel to the second edge 102. The trace arm extension 160 is positioned such that the radiator trace 150 is closer to the edge of the printed circuit board 180 than the trace arm extension 160.

The trace arm extension 160 is a small conductive trace, having a length between about 4 mm and 7 mm, that separated from the ground plane 100 by a small distance, such as between 0.2 mm and 0.5 mm. This separation allows the trace arm extension 160 to be capacitively coupled to the ground plane 100. Note that, in another embodiment, the trace arm extension 160 may be eliminated. Rather, a capacitor may be disposed between the radiator trace 150 and the ground plane 100 at the second edge 102.

In this embodiment, the tuning trace 130, the radiator trace 150, the trace arm extension 160, the second edge 102 cooperate to form a loop ground edge radiating antenna. This loop ground edge radiating antenna may be configured to operate at one of the two resonance frequencies. In certain embodiments, the loop ground edge radiating antenna operates at the lower of the two resonance frequencies. This resonance frequency may be between 2.40 GHz and 2.50 GHz. The resonance frequency of the loop ground edge radiating antenna is tuned by selection of the value of the input capacitor 120 and the length of the radiator trace 150 and the length of the trace arm extension 160. To achieve a resonance frequency around 2.45 GHz, the ground clearance 110 may be about 7 mm×10 mm, although other dimensions may be used for different frequency bands. Specifically, reducing the perimeter of the loop increases the resonance frequency of the loop ground edge radiating antenna. Conversely, increasing the perimeter of the loop decreases the resonance frequency of the loop ground edge radiating antenna.

Additionally, the tuning trace 130, the radiator trace 150, the first edge 101 cooperate to form a tapered slot antenna. The energy in the travelling wave is tightly bound to the radiator trace 150 when the separation between the radiator trace 150 and the first edge 101 (i.e. the slot 140) is very small compared to the free space wavelength and becomes progressively weaker and more coupled to the radiation field as the separation is increased. The tapered slot antenna may be tuned to the higher of the two resonance frequencies, such as about 5.5 GHz. The resonance frequency of the tapered slot antenna is tuned by modifying the length of the tuning trace 130. An increase in the length of the tuning trace 130 decreases the resonance frequency. Further, tuning of the loop ground edge radiating antenna has little effect on the operation of the tapered slot antenna.

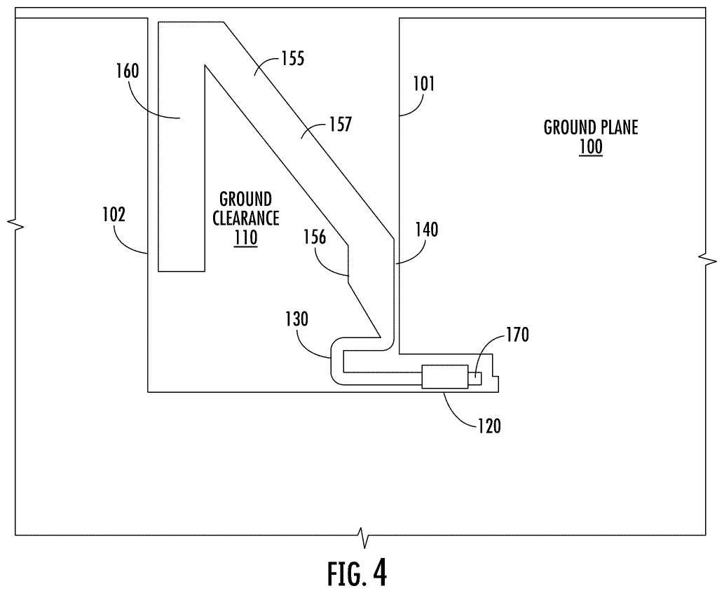

FIG. 4 shows a second embodiment. In this embodiment, identical components have been given the same references designators as shown in FIG. 3. In FIG. 4, the shape of the radiator trace 150 is modified. Rather than being rounded, the radiator trace 155 has two portions, a first portion 156 that is parallel to the first edge 101 to define the slot 140 and is in electrical communication with the tuning trace 130, and a second portion 157 that is slanted relative to the first edge 101 and travels at a slope toward the second edge 102 to create the taper. In this way, the distal end of the second portion 157 of the radiator trace 155 is closer to the edge of the printed circuit board 180 than the proximal end of the second portion 157. Note that the second portion 157 is straight, rather than rounded, as shown in FIG. 3. In certain systems, it may be simpler to fabricate a trace having the shape shown in FIG. 4. As was shown in FIG. 3, the first portion 156 of the radiator trace 155 is coupled to the tuning trace 130, while the second end of the second portion 157 of the radiator trace 155 terminates in a trace arm extension 160. The trace arm extension 160 is parallel to the second edge 102 and travels away from the edge of the printed circuit board 180. The length of the trace arm extension 160 may be between 4 and 7 mm with a width of between 0.5 mm and 2.0 mm.

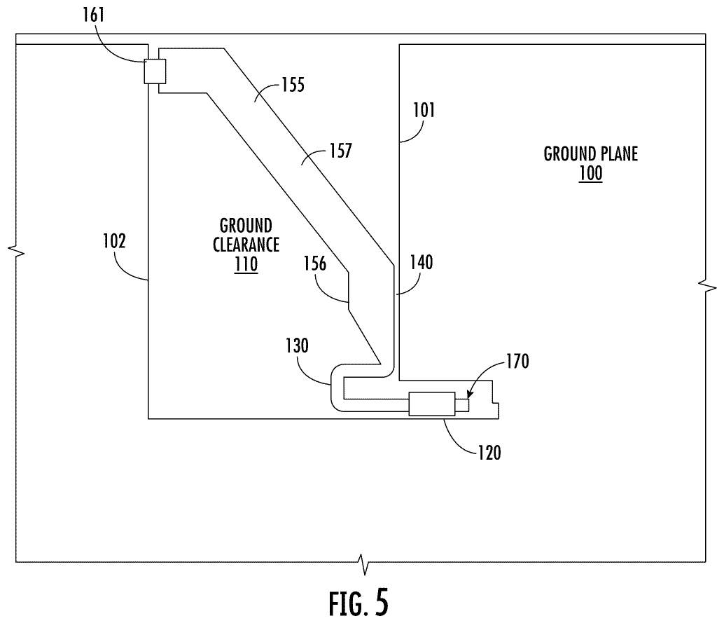

Note that as mentioned above, the trace arm extension 160 may be replaced with a capacitor. This is shown in FIG. 5, wherein the trace arm extension 160 is replaced with a capacitor 161. In this embodiment, the resonance frequency of the loop ground edge radiating antenna is tuned by modifying the length of the radiator trace 155 and the values of the input capacitor 120 and the capacitor 161.

In each of these embodiments, the tuning trace 130, the radiator trace, and the trace arm extension 160 (if present), like the rest of the ground plane 100, are a conductive material, such as copper.

In each of these configurations, the loop ground edge radiating antenna is tuned to have a resonance frequency of about 2.45 GHz, while the tapered slot antenna is tuned to have a resonance frequency of 5.5 GHz or more.

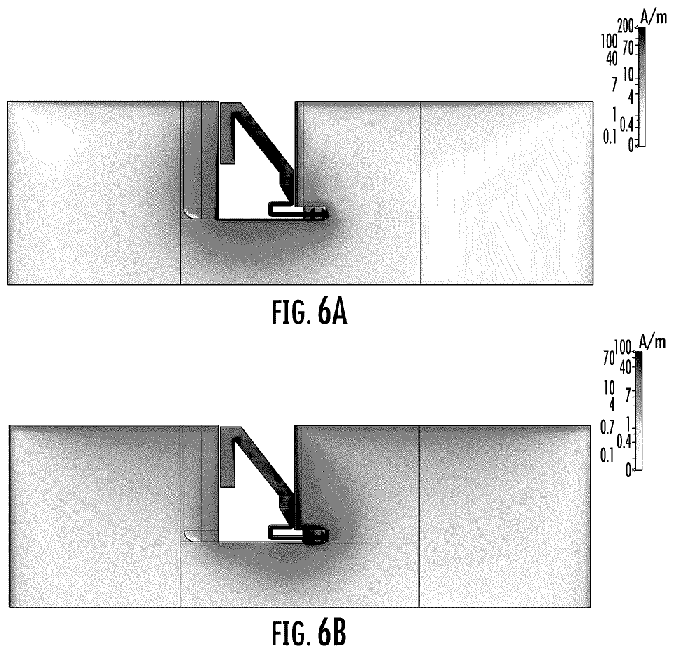

FIGS. 6A-6B shows the surface current paths experienced by the configuration in FIG. 4. FIG. 6A shows the surface current when radiating a signal in the range of 2.45 GHz. As noted above, the ground radiating loop type antenna is tuned for this frequency. The current flows through the tuning trace 130, the radiator trace 155, and the trace arm extension 160 and the second edge 102. The current also flows through the ground plane 100 adjacent to the ground clearance 110 from the trace arm extension 160 along the second edge 102 back toward the RF feed 170. An antenna radiator loop is created around the second edge 102 of the ground clearance 110. This antenna radiator loop allows the spread of loop-type current distributions on the ground plane 100 to be radiated outward. Note that almost no current passes through the ground plane 100 near the first edge 101.

FIG. 6B shows the surface current when radiating a signal in the range of 5.5 GHz. As noted above, the tapered slot antenna is tuned for this frequency. The current flows through the tuning trace 130, the first portion 156 of radiator trace 155, the second portion 157 of the radiator trace 155, and the first edge 101 of the ground clearance 110. Note that little current passes through the ground plane near the second edge 102.

Thus, the radiator trace 155 serves as both part of the tapered slot antenna and part of the loop ground edge radiating antenna. By having a portion of the radiator trace 155 that is parallel to and disposed very close to the first edge 101, a slot 140 is formed. The second portion of the radiator trace 155 serves as the taper, and also serves to provide much or the path for the loop ground edge radiating antenna through the ground clearance 110.

Note that while the RF feed 170 is located at the right side of the ground clearance 110, it may also be disposed at the bottom or the left side of the ground clearance 110.

Thus, in certain embodiments, the configuration of the loop ground edge radiating antenna is determined first. These parameters include the size of the ground clearance 110 (both length and width), as well as the selection of the values for the input capacitor 120 and the length of the trace arm extension 160 (or value of capacitor 161). Once the loop ground edge radiating antenna has been finetuned, the tapered slot antenna may be configured. Parameters such as the slope of the second portion 157 of the radiator trace 155, and the length of the tuning trace 130, may all be determined to establish the second resonance frequency. The value of the input capacitor 120, may be determined via simulation or empirical testing. In certain embodiments, the value may be less than 10 pF.

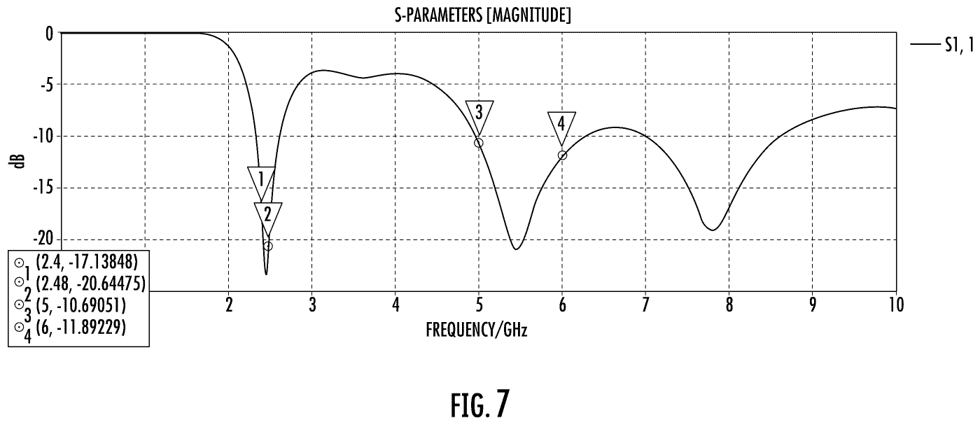

FIG. 7 shows the reflection coefficient (S11) of the antenna. For this graph, the ground clearance 110 was assumed to be 10 mm×6 mm. Note that the antenna has at least two resonant frequencies, which are clear in this graph. Because these frequencies are relatively far from one another, they create two bands where the reflection coefficient is less than −10dB. The first band occurs between roughly 2.3 GHz and 2.6 GHz, while the second band occurs between roughly 5.0 GHz and 6.5 GHz. In other words, the loop ground edge radiating antenna has a bandwidth of greater than 200 MHz, such as about 300 MHz, while the tapered slot antenna has a bandwidth of greater than 1000 MHz, such as roughly 1500 MHz. Note that the reflection coefficient at 6 GHz is less than −10dB, which is beneficial as this is the frequency band used by Wi-Fi 7 (also referred to as IEEE 802.11be). Further, this graph shows a third resonant frequency at about 7.8 GHz, with a third band from about 7 GHz to 8.6GHz, which results in a bandwidth of greater than 1000 MHz. This band is also used by Wi-Fi 7. Thus, this antenna may provide tri-band operation.

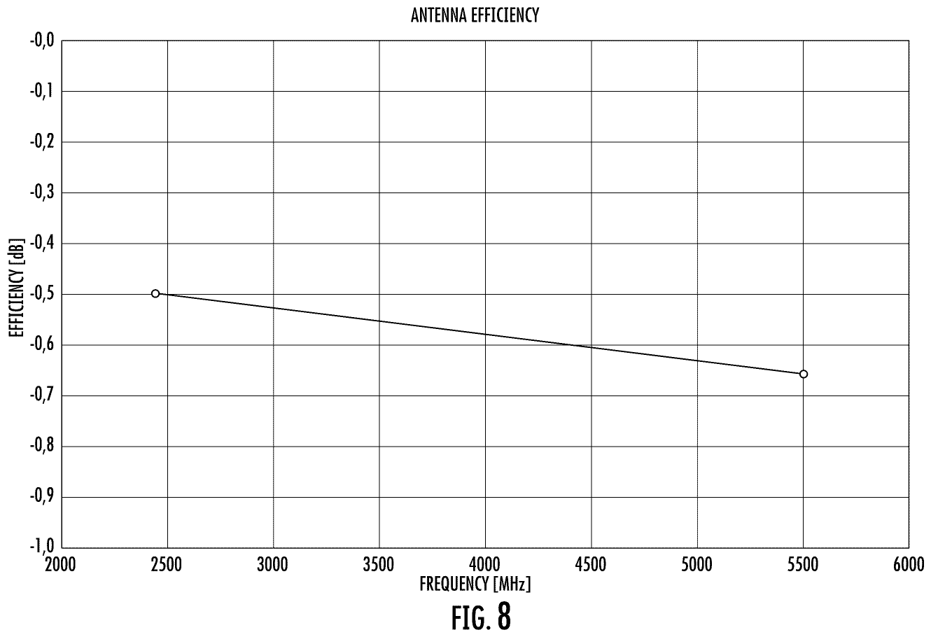

FIG. 8 shows the antenna efficiency, as measured in dB. In this disclosure, antenna efficiency is defined as the radiated power (P_{RAD}) divided by the input power (P_{INPUT}); in other words:

$${E}_{A} = {P}_{RAD} / {P}_{INPUT} .$$

Note that the total efficiency is greater than −0.7 dB for the entire range from 2.4 GHz and at 5.5 GHz.

Although the above disclosure describes the lower of the two resonance frequencies as being about 2.40 GHz to 2.50 GHz, it is understood that this lower resonance frequency may be changed to another value, such as 868 MHz or 915 MHz, by creating a larger loop. Additionally, the second resonance frequency may also be modified to another value, such as 2.4 GHz, by changing the length of the tuning trace 130. In other words, the antenna structure described herein may be configured to have two resonance frequencies, where each may be tailored by varying different design parameters of the antenna.

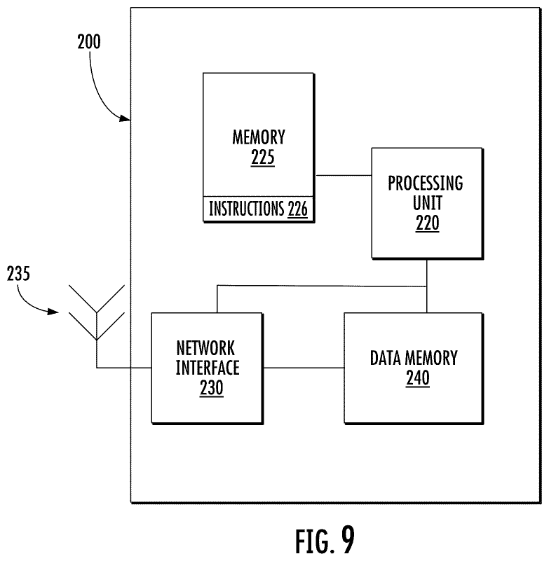

FIG. 9 shows a block diagram of a representative network device 200 that may utilize the dual band antenna described herein. This network device 200 may be able to operate at two different frequency bands, centered at two different center frequencies, such as 2.4 GHz and 5 GHz, for example. The network device 200 has a processing unit 220 and an associated memory device 225. The processing unit 220 may be any suitable component, such as a microprocessor, embedded processor, an application specific circuit, a programmable circuit, a microcontroller, or another similar device. This memory device 225 contains the instructions 226. This memory device 225 may be a non-volatile memory, such as a FLASH ROM, an electrically erasable ROM or other suitable devices. In other embodiments, the memory device 225 may be a volatile memory, such as a RAM or DRAM. The network device 200 also includes a network interface 230, which may be a wireless interface including the dual band antenna 235 described above. The network device 200 may include a data memory device 240 in which data that is received and transmitted by the network interface 230 is stored. This data memory device 240 is traditionally a volatile memory. The processing unit 220 has the ability to read and write the data memory device 240 so as to communicate with the other nodes in the network using the dual band antenna 235. Although not shown, the network device 200 also has a power supply, which may be a battery or a connection to a permanent power source, such as a wall outlet.

This system and method have many advantages. Many network devices require the ability to operate at multiple frequencies. More specifically, network devices may have to support two different frequencies for WiFi. Additionally, these devices may also support Bluetooth and one or more IEEE 802.15.4 protocols. The present antenna structure provides two different resonance frequencies, that correspond to the frequencies used for WiFi. Additionally, this antenna structure provides this functionality in a very small footprint. Further, in some embodiments, only one discrete component is required to implement the dual band antenna.

The present disclosure is not to be limited in scope by the specific embodiments described herein. Indeed, other various embodiments of and modifications to the present disclosure, in addition to those described herein, will be apparent to those of ordinary skill in the art from the foregoing description and accompanying drawings. Thus, such other embodiments and modifications are intended to fall within the scope of the present disclosure. Further, although the present disclosure has been described herein in the context of a particular implementation in a particular environment for a particular purpose, those of ordinary skill in the art will recognize that its usefulness is not limited thereto and that the present disclosure may be beneficially implemented in any number of environments for any number of purposes. Accordingly, the claims set forth below should be construed in view of the full breadth and spirit of the present disclosure as described herein.

What is claimed is:

1. A dual band antenna, comprising:
a printed circuit board having a ground plane on a top layer, wherein the ground plane comprises a conductive material;
a ground clearance disposed on the top layer, wherein the ground clearance lacks the conductive material;
a loop ground edge radiating antenna comprising a radiator trace disposed in the ground clearance; and
a tapered slot antenna formed by the radiator trace and a first edge of the ground plane.

2. The dual band antenna of claim 1, wherein the loop ground edge radiating antenna has a resonance frequency between 2.4 GHz and 2.5 GHz.

3. The dual band antenna of claim 1, wherein a bandwidth of the loop ground edge radiating antenna is at least 200 MHz.

4. The dual band antenna of claim 1, wherein the tapered slot antenna has a resonance frequency between 5.0 GHz and 6.0 GHz.

5. The dual band antenna of claim 1, wherein a bandwidth of the tapered slot antenna is at least 1000 MHz.

6. The dual band antenna of claim 1, wherein the ground clearance has dimensions that are equal to or less than 10 mm by 10 mm.

7. The dual band antenna of claim 1, wherein there are at least two different frequency ranges, wherein every frequency within the at least two different frequency ranges has a reflection coefficient of less than −10 dB.

8. The dual band antenna of claim 7, wherein there are three frequency ranges.

9. A network device, comprising:
a processing unit;
a memory device in communication with the processing unit;
a network interface in communication with the dual band antenna of claim 1; and
a data memory device to store data to be transmitted and received using the dual band antenna.

10. A dual band antenna, comprising:
a printed circuit board having a ground plane on a top layer, wherein the ground plane comprises a conductive material;
a ground clearance disposed on the top layer, wherein the ground clearance is rectangular shaped and lacks the conductive material, wherein a side of the ground clearance is an edge of the printed circuit board and a first edge and a second edge are adjacent to the side;
a tuning trace disposed in the ground clearance, a proximal end of the tuning trace in communication with an input capacitor and a RF feed; and
a radiator trace in communication with a distal end of the tuning trace, wherein a first portion of the radiator trace is adjacent to the first edge so as to form a slot, and a second portion of the radiator trace extends away from the first edge and toward the second edge, and wherein a distal end of the second portion is capacitively coupled to the ground plane at the second edge.

11. The dual band antenna of claim 10, further comprising a capacitor in communication with the ground plane at the second edge and the distal end of the second portion of the radiator trace.

12. The dual band antenna of claim 10, further comprising a trace arm extension disposed parallel to the second edge to capacitively couple the distal end of the second portion to the ground plane.

13. The dual band antenna of claim 12, wherein the trace arm extension is disposed between 0.2 mm and 0.5 mm from the second edge.

14. The dual band antenna of claim 10, wherein the slot has a width of between 0.1 and 0.5 mm.

15. The dual band antenna of claim 14, wherein the slot has a length of between 0.5 and 2.0 mm.

16. The dual band antenna of claim 10, wherein the ground clearance has dimensions that are equal to or less than 10 mm by 10 mm.

17. The dual band antenna of claim 10, wherein the second portion of the radiator trace is rounded and is closer to the edge of the printed circuit board at the distal end than at a proximal end.

18. The dual band antenna of claim 10, wherein the second portion of the radiator trace is straight and slants toward the second edge.

19. The dual band antenna of claim 18, wherein the distal end of the second portion is closer to the edge of the printed circuit board than a proximal end.

20. A network device, comprising:
a processing unit;
a memory device in communication with the processing unit;
a network interface in communication with the dual band antenna of claim 10; and
a data memory device to store data to be transmitted and received using the dual band antenna.
